(19) United States
(12) Patent Application Publication
(10) Pub. No.: US 2008/0183631 A1
(43) Pub. Date: Jul. 31, 2008

(54) Process for pairing off parties on a real estate and housing market

(76) Inventors: Mikko Ranin, Espoo (FI); Jussi Nurmio, Helsinki (FI); Esa Rauhala, Helsinki (FI)

Correspondence Address: YOUNG & THOMPSON, 209 Madison Street, Suite 500, ALEXANDRIA, VA, 22314, US

(21) Appl. No.: 11/699,357

(22) Filed: Jan. 30, 2007

(51) Int. Cl. G06Q 30/00

(52) U.S. Cl. 705/80

(57) ABSTRACT

The invention provides a process for pairing off parties on a real estate and housing market such that the parties are enabled to limit and manage economical risks associated with transactions and contracts. A potential buyer or tenant is enabled to submit an earmarking advertisement defining constraint requirements for an object being searched for. A potential seller or landlord is enabled to submit an anonymous offering advertisement that includes information about an object on sale or on hire. A service provider checks whether the object on sale or on hire has potential to match the constraint requirements of the object being searched for. If the object being offered has potential to match the constraint requirements, the service provider contacts the potential seller or landlord and/or the potential buyer or tenant for inquiring about willingness for further negotiations.

### FIELD OF THE INVENTION

The invention relates to a process for pairing off a potential seller or a potential landlord with a potential buyer or a potential tenant on a real estate and/or housing market.

### BACKGROUND

Conventional processes for pairing off potential buyers or tenants with potential sellers or landlords on a real estate and housing market include newspaper advertisements, advertisements published in a data network, e.g. Internet, and/or presentations organized by a person selling or hiring out a real estate or a dwelling or by his/her agent. On the present real estate and housing market, there are a lot of objects on sale and on hire at the same time especially in growth centres. Because of the large number of objects being offered on the real estate and housing market there is a considerable risk that a potential buyer or a potential tenant fails to notice an object on sale or on hire, which he/she might be interested in. The present data network technology can be used to improve the situation, for example, so that the potential buyer or tenant looking for a suitable object or generally surveying the market conditions can define constraint requirements, such as the location area, the upper price limit, the surface area of the building or the dwelling, etc., which an object on sale or on hire should meet. Then, the potential buyer can perform a retrieval, which only yields the offering advertisements of those objects on sale or on hire, which meet the above-mentioned constraint requirements. In that case, the potential buyer or tenant can reduce the number of objects in advance and reduce the number of visits to presentations, which require time and money. It is also possible for a potential buyer or tenant to place in a newspaper and/or in a data network a purchase advertisement provided with constraint requirements chosen by him/her.

For private persons a transaction concerning a real estate or dwelling is usually such a major one that either a potential seller or a potential buyer or both of them can be insecure about his/her knowledge concerning the prevailing price level and other market conditions in relation to the subjective significance of the transaction in progress. The situation is especially difficult for a person who wants to sell his/her existent real estate or dwelling and to buy another real estate or dwelling that should be e.g. bigger than the existent one. It is somewhat risky to sell the existent real estate or dwelling before finding the other real estate or dwelling and achieving a reasonable security of being able to buy the other real estate or dwelling. On the other hand, it is also somewhat risky to make a firm bid to the owner of the other real estate or dwelling before selling the existent real estate or dwelling or before receiving a firm bid on the existent real estate or dwelling. In principle, similar economical risks, but in a milder form, are present when a tenant is changing a landlord. A notice of a termination of an existent tenancy agreement should be given as early as possible in order to minimise costs but, on the other hand, such a notice should not be given before finding a suitable other real estate or dwelling and achieving a reasonable security of being able to rent the other real estate or dwelling.

Publication US 2002/0082964 A1 describes a system, wherein a potential seller may place a sales advertisement that is provided with distinguishing features, on a home page of a real estate agent in a data network and, correspondingly, a potential buyer can place a purchase advertisement provided with constraint requirements on the home page of the real estate agent. The potential buyer can contact the potential seller directly for further negotiations. However, to follow the changing supply, the potential buyer must actively retrieve from the data network the objects that are on sale at each time. The potential buyer is offered an opportunity to compile a list of objects on sale he or she is interested in. Contact information of the potential buyer is transferred to those potential sellers, the sales objects of whom the potential buyer has selected into the list. Contact information of a potential buyer, who might be interested in a certain object on sale but who has not noticed that particular object because of the large number of objects on sale, is not transmitted to the potential seller that is selling the object.

The above-described processes for pairing off parties on the real estate and/or housing market are characterized in that a potential seller selling a given object and, correspondingly, a potential buyer looking for a suitable object must often show considerable activity and diligence to improve their knowledge of the market in order to manage risks associated with transactions and making contracts on the real estate and housing market. Consequently, there is a considerable demand for processes, which can be used to offer potential buyers, potential sellers, potential tenants, and potential landlords ways to limit and/or manage the above-mentioned economical risks associated with transactions and contracts on the real estate and housing market and to help the potential buyers and landlords to search for suitable objects.

### SUMMARY

An object of the invention is to provide a process for pairing off parties on the real estate and/or housing market.

A process according to the invention for pairing off parties on a real estate and housing market is characterised in that the process comprises:
a service provider enables a first party to submit an earmarking advertisement and a second party to submit an offering advertisement, said earmarking advertisement defining constraint requirements for an object being searched for, said offering advertisement including information about an object being offered, and said second party being enabled to submit said offering advertisement without showing identifying information of said second party to said first party,
the service provider checks whether said object being offered has potential to match said constraint requirements defined in said earmarking advertisement, and
as a response to a situation in which said object being offered has potential to match said constraint requirements, the service provider inquires about willingness for further negotiations of at least one of the following: said first party and said second party.

A number of embodiments of the invention are described in accompanied dependent claims.

The embodiments of invention provide considerable advantages:

a potential seller or a potential landlord is given a comfortable way to anonymously survey interest of potential buyers or tenants towards an object on sale or on hire, and

a potential buyer or tenant is given a comfortable way to express his/her interest towards certain objects without having to actively follow sales advertisements in newspapers, data networks, or other media; for example, constraint requirements of an earmarking advertisement may require that e.g. a dwelling being searched for is located in a desired building or in a desired block of houses even if, on that moment, no dwelling of the mentioned building or block of houses were on sale or on hire.

Various embodiments of the invention together with additional objects and advantages will be best understood from the following description of specific embodiments when read in connection with the accompanying drawings.

The embodiments of the invention presented in this document are not to be interpreted to pose limitations to the applicability of the appended claims. The verb “to comprise” is used in this document as an open limitation that does not exclude the existence of also unrecited features. The features recited in depending claims are mutually freely combinable unless otherwise explicitly stated.

### BRIEF DESCRIPTION OF THE FIGURES

The invention and its advantages are explained in greater detail below with reference to the embodiments presented in the sense of examples and with reference to the accompanying drawings, in which:

FIG. 1 is a flow chart of a process according to a first embodiment of the invention for pairing off parties on a real estate and housing market,

FIG. 2 shows an example of a data network arrangement that can be used as a physical operational environment for a process according to an embodiment of the invention for pairing off parties on a real estate and housing market,

FIG. 3 is a flow chart of a process according to a second embodiment of the invention for pairing off parties on a real estate and housing market,

FIG. 4 is a flow chart of a process according to a third embodiment of the invention for pairing off parties on a real estate and housing market,

FIG. 5 is a flow chart of a process according to a fourth embodiment of the invention for pairing off parties on a real estate and housing market,

FIG. 6 is a flow chart of a process according to a fifth embodiment of the invention for pairing off parties on a real estate and housing market,

FIG. 7 is a flow chart of a process according to a sixth embodiment of the invention for pairing off parties on a real estate and housing market,

FIG. 8 is a flow chart of a process according to a seventh embodiment of the invention for pairing off parties on a real estate and housing market,

FIG. 9 is a flow chart of a process according to an eighth embodiment of the invention for pairing off parties on a real estate and housing market,

FIG. 10 shows an example of an offering advertisement that can be used in a process according to an embodiment of the invention, and

FIG. 11 shows an example of an earmarking advertisement that can be used in a process according to an embodiment of the invention.

### DETAILED DESCRIPTION OF THE EMBODIMENTS

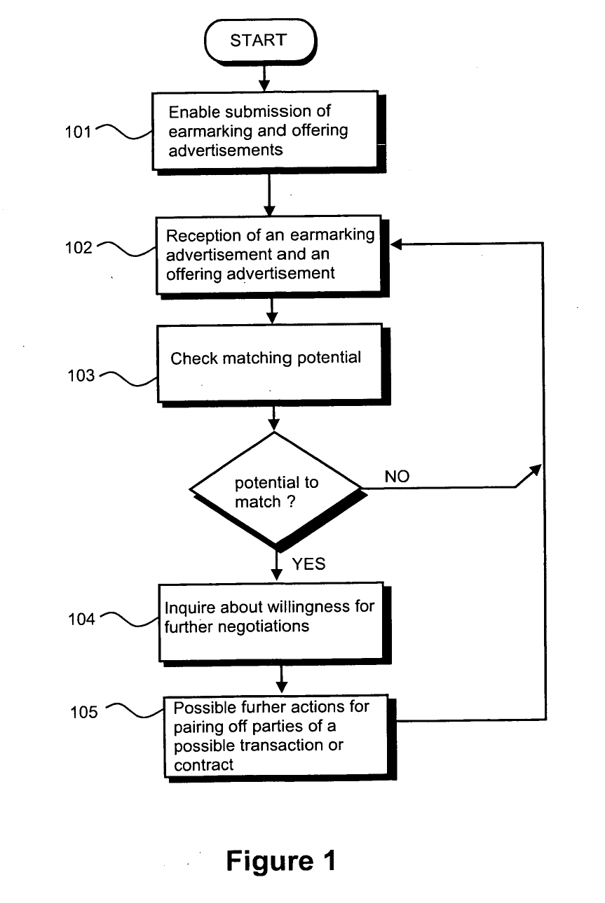

FIG. 1 shows a flow chart of a process according to an embodiment of the invention for pairing off parties on a real estate and housing market. A service provider, e.g. a real estate agency, enables 101 a first party to submit an earmarking advertisement that defines constraint requirements for an object being searched for. The first party can be, for example, a potential buyer or a potential tenant who is looking for an object, e.g. a real estate or a dwelling, that satisfies his/her needs. The service provider enables 101 a second party to submit an offering advertisement that includes information about an object on sale or on hire. The second party is enabled to submit the offering advertisement without showing identifying information of the second party to the first party. The second party can be, for example, a potential seller or a potential landlord that has an object, e.g. a real estate or a dwelling, on sale or on hire. The identifying information of the second party can be any piece of information that can be used for finding out the identity of the second party, e.g. the name of the second party, an exact address of the object being offered, etc. A potential seller or landlord is enabled to submit an offering advertisement without showing his/her identifying information to the public or to potential buyers and tenants in order to allow the potential seller or landlord to survey anonymously and without commitments the interest towards the object on sale or on hire on the real estate and housing market.

A potential seller or landlord can be enabled to determine whether or not the identifying information of the potential seller or landlord is shown in an offering advertisement to potential buyers or tenants and to the public. Correspondingly, a potential buyer or tenant can be enabled to determine whether or not the identity information of the potential buyer or tenant is shown in an earmarking advertisement to potential sellers or landlords and to the public.

After the service provider has received 102 an earmarking advertisement and an offering advertisement, the service provider checks 103 whether the object, e.g. a real estate or a dwelling, being offered in the offering advertisement has potential to match the constraint requirements defined in the earmarking advertisement. For example, the earmarking advertisement may require that a dwelling is located in a desired building or in a desired block of houses even if, on that moment, no dwelling of the mentioned building or block of houses were on sale or on hire. As a response to a situation in which the object being offered in the offering advertisement has potential to match the constraint requirements defined in the earmarking advertisement, the service provider inquires 104 about willingness for further negotiations of at least one of the following: the potential seller or landlord and the potential buyer or tenant.

After the above-mentioned inquiry/inquiries 104, possible further actions 105 for pairing off the potential seller or landlord and the potential buyer or tenant can take place. The possible further actions can include, for example, delivery of contact information of the potential seller or landlord to the potential buyer or tenant or vice versa.

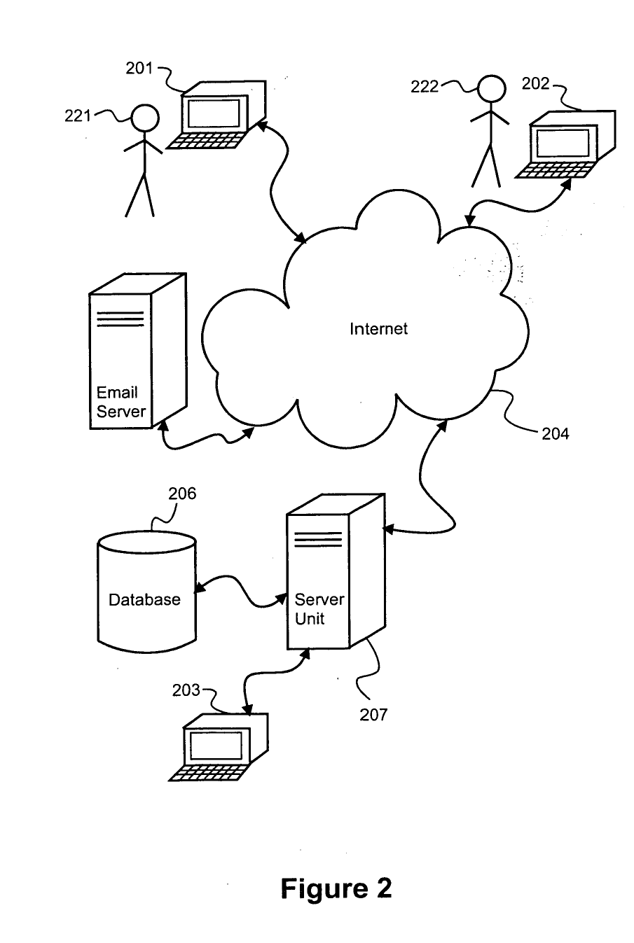

FIG. 2 shows an example of a data network arrangement that can be used as a physical operational environment for a process according to an embodiment of the invention for pairing off parties on a real estate and housing market. A potential buyer or tenant 221 generates an earmarking advertisement using a user interface of a first terminal device 201 connected to a data network 204. The data network 204 can be for example the Internet. A potential seller or landlord 222 generates an offering advertisement using a user interface of a second terminal device 202 connected to the data network 204. The earmarking advertisement and the offering advertisement are loaded into a database 206 of a server device 207 that has been connected to the data network 204. A service provider receives the earmarking advertisement and the offering advertisement by downloading the earmarking advertisement and the offering advertisement from the database 206. Data transfer between the terminal devices 201 and 202 and the server device 207 can be arranged, for example, with the aid of the common electrical mail service.

The service provider checks whether the object, e.g. a real estate or a dwelling, being offered in the offering advertisement has potential to match constraint requirements defined in the earmarking advertisement.

In a process according to an embodiment of the invention the checking is performed as human labour with the aid of a terminal device 203 that has access to earmarking advertisements and offering advertisements stored in the database 206.

In a process according to an embodiment of the invention the checking is performed automatically with a computer that has access to earmarking advertisements and offering advertisements stored in the database 206.

In a process according to an embodiment of the invention a preliminary search of possible matches between offering advertisements and earmarking advertisements is performed automatically with a computer that has access to earmarking advertisements and offering advertisements stored in the database 206, and a final checking is performed as human labour.

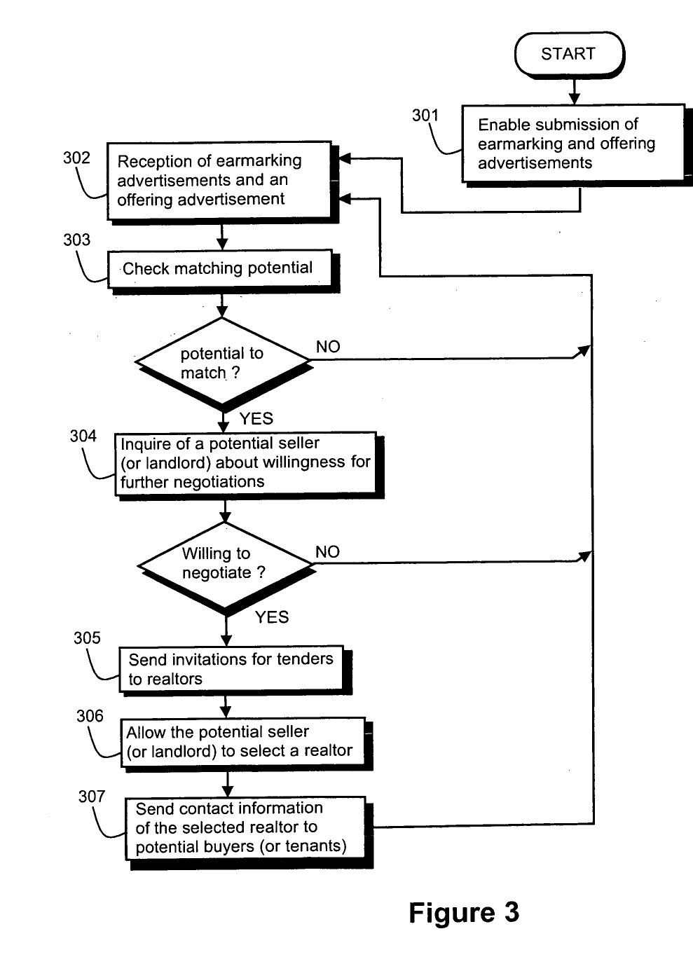

FIG. 3 is a flow chart of a process according to an embodiment of the invention for pairing off parties on a real estate and housing market. A service provider, e.g. a real estate agency, enables 301 potential sellers or landlords to submit offering advertisements and potential buyers or tenants to submit earmarking advertisements. After receiving 302 an offering advertisement and one or more earmarking advertisements, the service provider checks 303 whether an object being offered in the offering advertisement has potential to match constraint requirements of any of the earmarking advertisements. As a response to a situation in which the object being offered in the offering advertisement has potential to match constraint requirements of at least one of the earmarking advertisements, the service provider inquires 304 of the potential seller or landlord about willingness for further negotiations.

If the potential seller or landlord is willing to negotiate, invitations for tenders to operate as an agent of the potential seller or landlord are sent 305 to one or more realtors. The potential seller or landlord is allowed 306 to select at least one realtor from the one or more realtors on the basis of tenders responding to the above-mentioned invitations for tenders. The potential seller or landlord can enter with the selected at least one realtor into an agency contract dealing with a possible transaction or tenancy agreement associated with the object being offered in the offering advertisement. If the agency contract is formed, contact information of the selected at least one realtor is delivered 307 to the potential buyers or tenants whose constraint requirements of earmarking advertisements are potentially matched by the object being offered in the offering advertisement. In this embodiment of the invention one or more potential buyers or tenants receive contact information of a realtor who acts as an agent of a potential seller or landlord having an object on sale or on hire, e.g. a dwelling or a real estate, that might satisfy the needs of the potential buyers or tenants.

In a process according to an alternative embodiment of the invention one or more potential sellers or landlords receive contact information of a realtor who acts as an agent of a potential buyer or tenant who might be interested in objects, e.g. dwellings or real estates, being offered in offering advertisements. A process according to this alternative embodiment of the invention is described below.

A service provider, e.g. a real estate agency, enables potential sellers or landlords to submit offering advertisements and potential buyers or tenants to submit earmarking advertisements. After receiving one or more offering advertisement and an earmarking advertisement, the service provider checks whether any of objects being offered in the offering advertisements has potential to match constraint requirements of the earmarking advertisement. As a response to a situation in which at least one of the objects being offered in the offering advertisements has potential to match the constraint requirements of the earmarking advertisement, the service provider inquires of the potential buyer or tenant about willingness for further negotiations.

If the potential buyer or tenant is willing to negotiate, invitations for tenders to operate as an agent of the potential buyer or tenant are sent to one or more realtors. The potential buyer or tenant is allowed to select at least one realtor from the one or more realtors on the basis of tenders responding to the above-mentioned invitations for tenders. The potential buyer or tenant can enter with the selected at least one realtor into an agency contract dealing with a searching assignment for a suitable object, e.g. a dwelling or a real estate, for the potential buyer or tenant. If the agency contract is formed, contact information of the selected at least one realtor is delivered to the potential sellers or landlords whose objects, e.g. dwellings or real estates, have potential to match the constraint requirements of the earmarking advertisement.

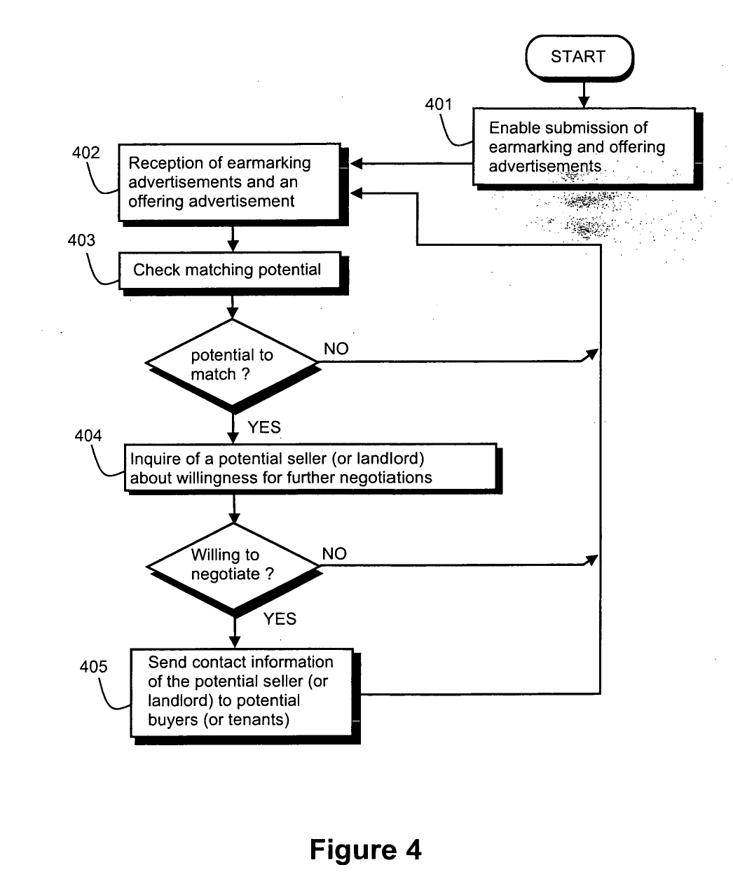

FIG. 4 is a flow chart of a process according to an embodiment of the invention for pairing off parties on a real estate and housing market. A service provider, e.g. a real estate agency, enables 401 potential sellers or landlords to submit offering advertisement and potential buyers or tenants to submit earmarking advertisement. After receiving 402 an offering advertisement and one or more earmarking advertisements, the service provider checks 403 whether an object being offered in the offering advertisement has potential to match constraint requirements of any of the earmarking advertisements. As a response to a situation in which the object being offered in the offering advertisement has potential to match constraint requirements of at least one of the earmarking advertisements, the service provider inquires 404 of the potential seller or landlord about willingness for further negotiations.

If the potential seller or landlord is willing to negotiate, contact information of the potential seller or landlord is delivered 405 to the potential buyers or tenants whose constraint requirements of earmarking advertisements are potentially matched by the object being offered in the offering advertisement. In this embodiment of the invention one or more potential buyers or tenants receive contact information of a potential seller or landlord having an object on sale or on hire, e.g. a dwelling or a real estate, that might satisfy the needs of the potential buyers or tenants.

In a process according to an alternative embodiment of the invention one or more potential sellers or landlords receive contact information of a potential buyer or tenant who might be interested in an object, e.g. a dwelling or a real estate, being offered in an offering advertisement. A process according to this alternative embodiment of the invention is described below.

A service provider, e.g. a real estate agency, enables potential sellers or landlords to submit offering advertisement and potential buyers or tenants to submit earmarking advertisement. After receiving one or more offering advertisement and an earmarking advertisement, the service provider checks whether any of objects being offered in the offering advertisements has potential to match the earmarking advertisement. As a response to a situation in which at least one of the objects being offered in the offering advertisements has potential to match constraint requirements of the earmarking advertisement, the service provider inquires of the potential buyer or tenant about willingness for further negotiations.

If the potential buyer or tenant is willing to negotiate, contact information of the potential buyer or tenant is delivered to the potential sellers or landlords whose objects, e.g. dwellings or real estates, have potential to match the constraint requirements of the earmarking advertisements.

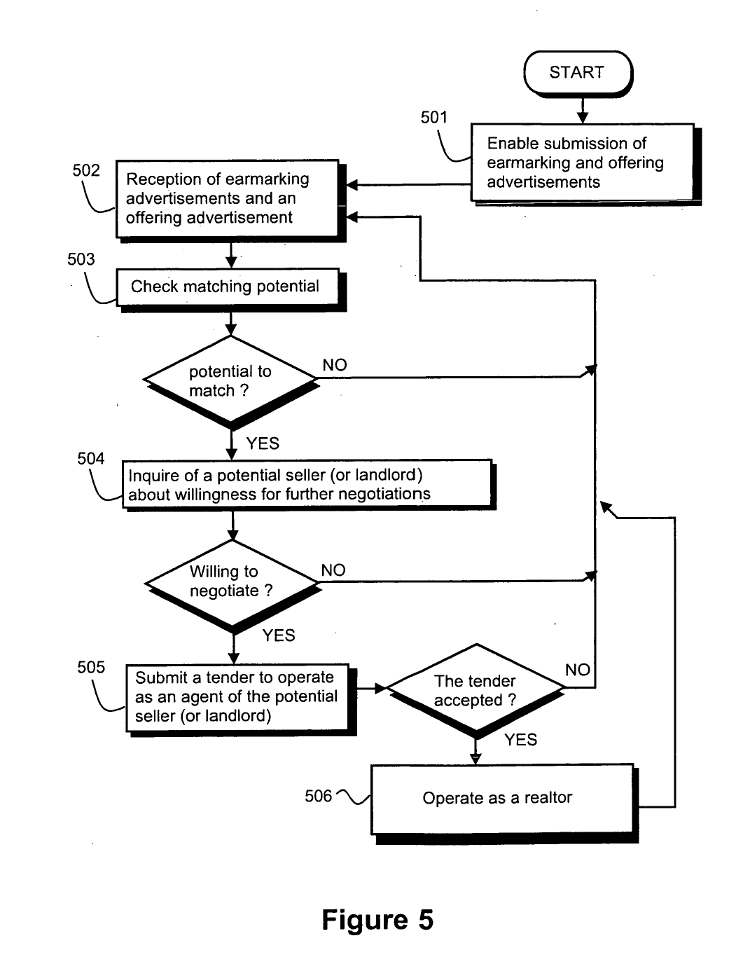

FIG. 5 is a flow chart of a process according to an embodiment of the invention for pairing off parties on a real estate and housing market. A service provider enables 501 potential sellers or landlords to submit offering advertisements and potential buyers or tenants to submit earmarking advertisements. After receiving 502 an offering advertisement and one or more earmarking advertisements, the service provider checks 503 whether an object being offered in the offering advertisement has potential to match constraint requirements of any of the earmarking advertisements. As a response to a situation in which the object being offered in the offering advertisement has potential to match constraint requirements of at least one of the earmarking advertisements, the service provider inquires 504 of the potential seller or landlord about willingness for further negotiations.

If the potential seller or landlord is willing to negotiate, the service provider submits 505 to the potential seller or landlord a tender to operate as an agent of the potential seller or landlord. The potential seller or landlord can enter with the service provider into an agency contract dealing with a possible transaction or tenancy agreement associated with the object being offered in the offering advertisement. If the agency contract is formed, the service provider operates 506 as a realtor concerning the object being offered in the offering advertisement. The service provider informs the potential buyers or tenants, whose constraint requirements of earmarking advertisements are potentially matched by the object being offered, about the fact that the service provider has an assignment to sell or hire out an object that might satisfy the needs of the potential buyers or tenants.

In a process according to an alternative embodiment of the invention a service provider informs potential sellers or landlords about the fact that the service provider has an assignment to search an object that might be an object being offered in an offering advertisement submitted by a potential seller or landlord. A process according to this alternative embodiment of the invention is described below.

A service provider enables potential sellers or landlords to submit offering advertisements and potential buyers or tenants to submit earmarking advertisements. After receiving one or more offering advertisements and an earmarking advertisement, the service provider checks whether any of objects being offered in the offering advertisements has potential to match constraint requirements of the earmarking advertisement. As a response to a situation in which at least one of the objects being offered in the offering advertisements has potential to match the constraint requirements of the earmarking advertisement, the service provider inquires of the potential buyer or tenant about willingness for further negotiations.

If the potential buyer or tenant is willing to negotiate, the service provider submits to the potential buyer or tenant a tender to operate as an agent of the potential buyer or tenant. The potential buyer or tenant can enter with the service provider into an agency contract dealing with an assignment to search a suitable object, e.g. a dwelling or a real estate. If the agency contract is formed, the service provider operates as a realtor that searches for a suitable object on the real estate and housing market. The service provider informs the potential sellers or landlords, whose objects on sale or on hire have potential to match the constraint requirements of the earmarking advertisement, about the fact that the service provider has an assignment to search for an object that might be an object being offered in an offering advertisement submitted by a potential seller or landlord.

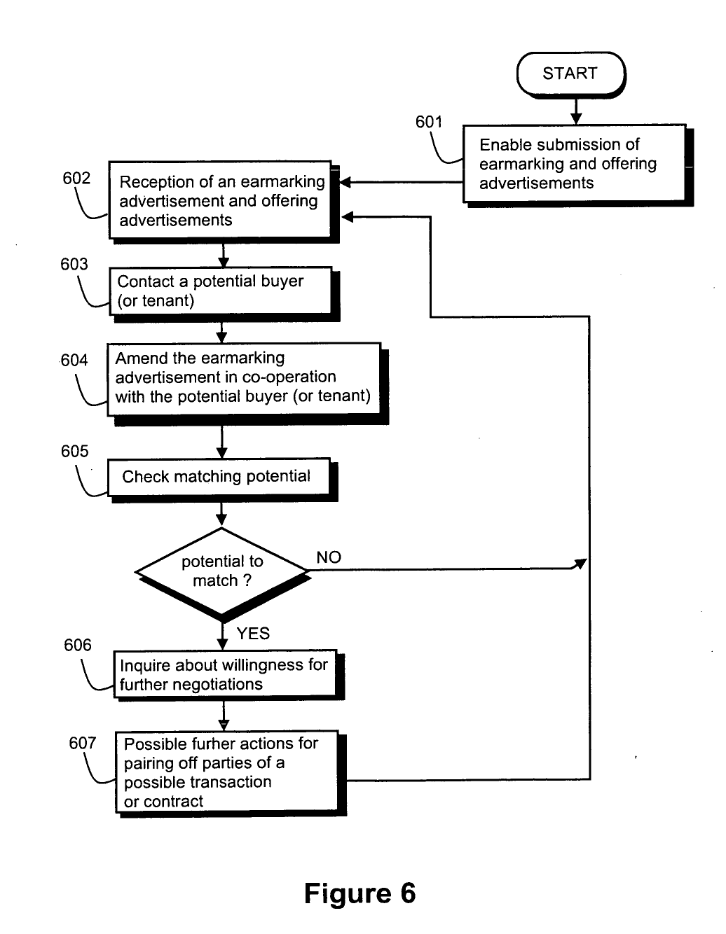

FIG. 6 is a flow chart of a process according to an embodiment of the invention for pairing off parties on a real estate and housing market. A service provider enables 601 potential sellers or landlords to submit offering advertisements and potential buyers or tenants to submit earmarking advertisements. After receiving 602 an earmarking advertisement, the service provider contacts 603 a potential buyer or tenant that has submitted the earmarking advertisement and helps 604 the potential buyer or tenant to further develop the earmarking advertisement to correspond better with the needs of the potential buyer or tenant. Process actions 605, 606, and 607 can be similar to the corresponding process actions in any of the embodiments described in the text above and with the aid of FIGS. 1, 3, 4, and 5.

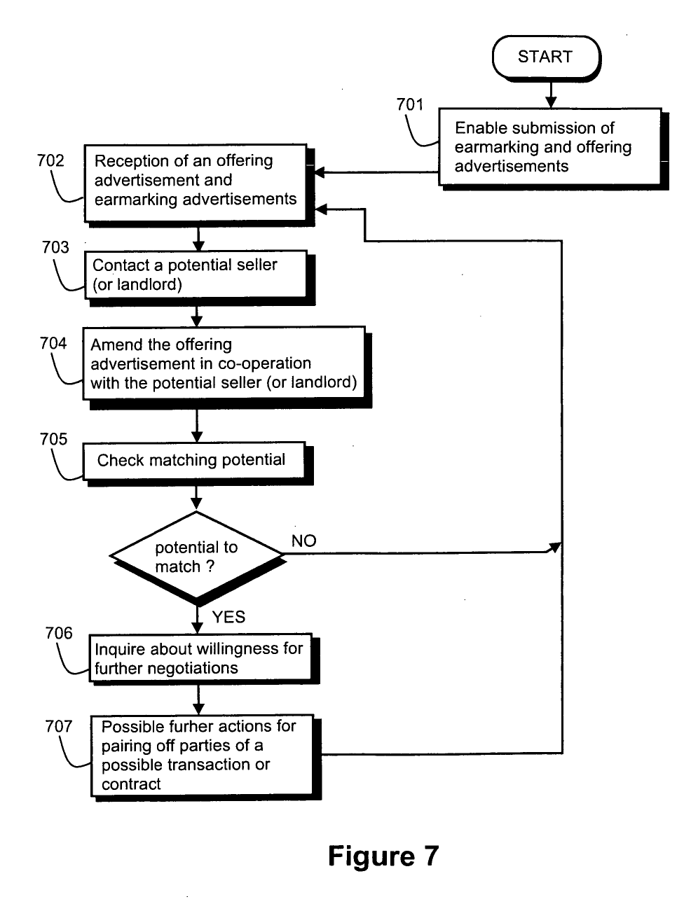

FIG. 7 is a flow chart of a process according to an embodiment of the invention for pairing off parties on a real estate and housing market. A service provider enables 701 potential sellers or landlords to submit offering advertisements and potential buyers or tenants to submit earmarking advertisements. After receiving 702 an offering advertisement, the service provider contacts 703 a potential seller or landlord that has submitted the offering advertisement and helps 704 the potential seller or landlord to further develop the offering advertisement to correspond better with the object on sale or on hire. Process actions 705, 706, and 707 can be similar to the corresponding process actions in any of the embodiments described in the text above and with the aid of FIGS. 1, 3, 4, and 5.

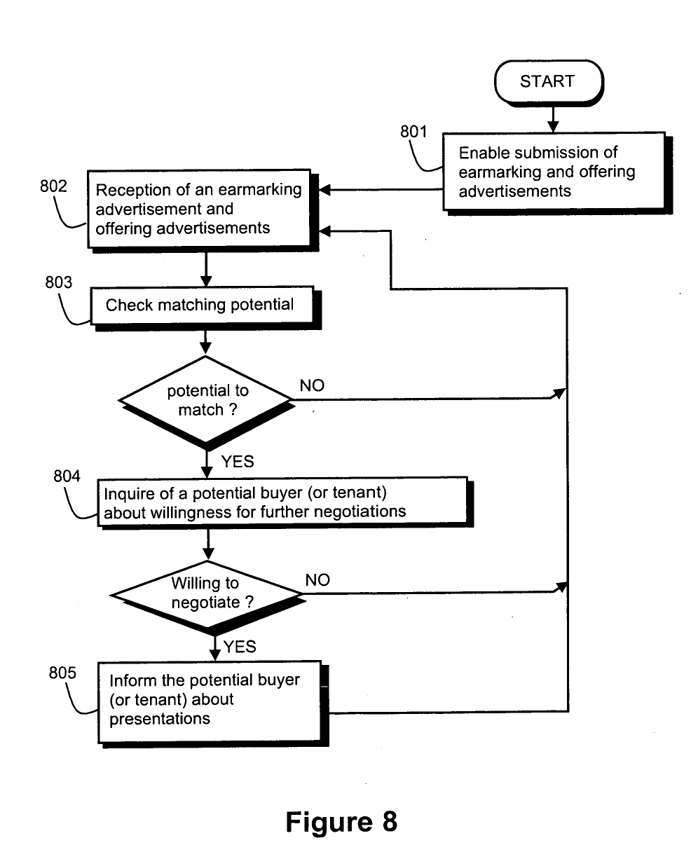

FIG. 8 is a flow chart of a process according to an embodiment of the invention for pairing off parties on a real estate and housing market. A service provider enables 801 potential sellers or landlords to submit offering advertisements and potential buyers or tenants to submit earmarking advertisements. After receiving 802 one or more offering advertisement and an earmarking advertisement, the service provider checks 803 whether any of objects being offered in the offering advertisements has potential to match constraint requirements of the earmarking advertisement. As a response to a situation in which at least one object being offered in the offering advertisements has potential to match the constraint requirements of the earmarking advertisements, the service provider inquires 804 of the potential buyer or tenant about willingness for further negotiations.

If the potential buyer or tenant is willing to negotiate, the service provider informs 805 the potential buyer or tenant about presentations concerning the objects, e.g. dwellings or real estates, that are offered in the offering advertisements and have potential to match the constraint requirements of the earmarking advertisement. The information about a presentation can comprise date, time, and address associated with the presentation.

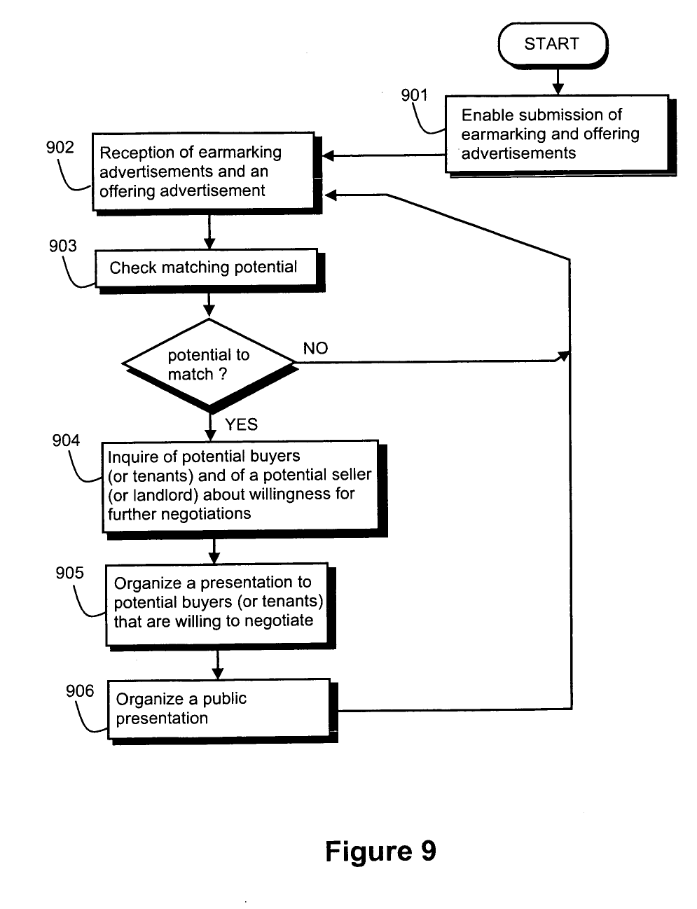

FIG. 9 is a flow chart of a process according to an embodiment of the invention for pairing off parties on a real estate and housing market. A service provider enables 901 potential sellers or landlords to submit offering advertisements and potential buyers or tenants to submit earmarking advertisements. After receiving 902 an offering advertisement and one or more earmarking advertisements, the service provider checks 903 whether an object being offered in the offering advertisement has potential to match constraint requirements of any of the earmarking advertisements. As a response to a situation in which the object being offered in the offering advertisements has potential to match constraint requirements of at least one of the earmarking advertisements, the service provider inquires 904 of the potential seller or landlord and of potential buyers or tenants, whose constraint requirements of earmarking advertisements are potentially matched by the object being offered, about willingness for further negotiations.

If the potential seller or landlord and at least one of the potential buyers or tenants are willing to negotiate, the service provider organizes 905 for the potential buyers or tenants a first presentation concerning the object, e.g. a dwelling or a real estate, being offered. After the first presentation, the service provider organizes 906 a public presentation concerning the object being offered.

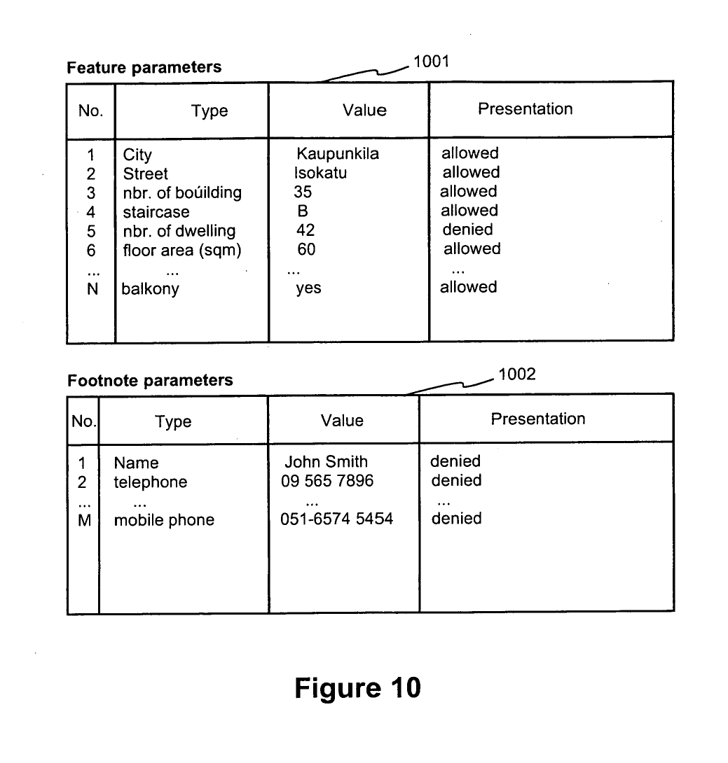

An example of an offering advertisement that can be used in a process according to an embodiment of the invention is shown in FIG. 10. A potential seller or landlord submitting the offering advertisement can select 1 . . . N (N being an integer) different types of feature parameters 1001 that define distinguishing features of an object on sale or on hire. An offering advertisement can be compared with earmarking advertisements on the basis of these parameters. Furthermore, the potential seller can select 1 . . . M (M being an integer) different types of footnote parameters 1002 that define other information related to the offering advertisement, such as the contact information of the potential seller or landlord. In this example, the potential seller or landlord is enabled to determine whether a feature parameter or a footnote parameter is shown to the public and to potential buyers or tenants.

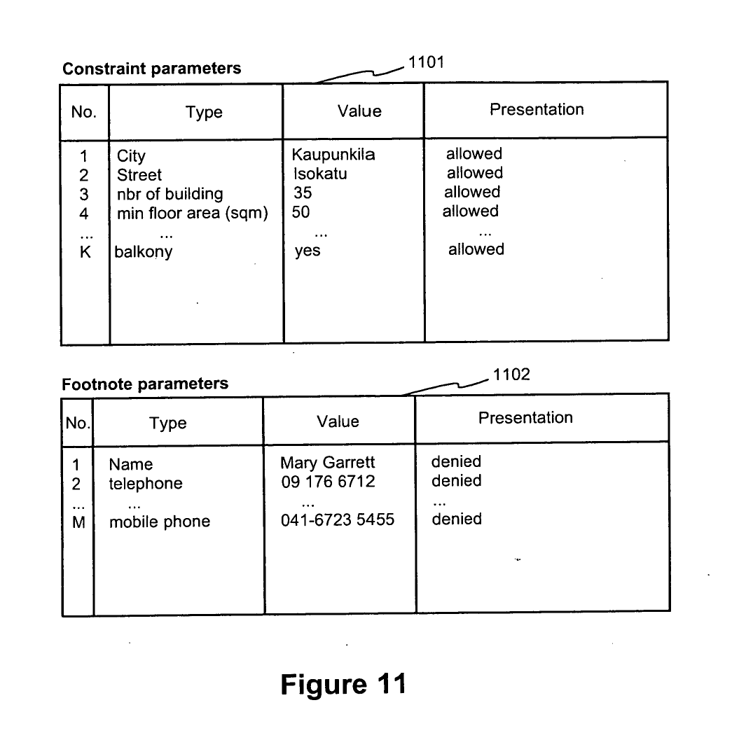

An example of an earmarking advertisement that can be used in a process according to an embodiment of the invention is shown in FIG. 11. A potential buyer or tenant submitting an earmarking advertisement can select 1 . . . K (K being an integer) different types of constraint parameters 1101 that define constraint requirements for an object being searched for. Furthermore, the potential buyer or tenant can select 1 . . . L (L being an integer) different types of footnote parameters 1120, that define the information related to the earmarking advertisement, such as the contact information of the potential buyer or tenant. In this example, the potential buyer or tenant is enabled to determine whether a constraint parameter or a footnote parameter is shown to the public and to potential sellers or landlords. In this example case, the object being offered in the offering advertisement shown in figure 10 has potential to march the constraint requirements of the earmarking advertisement shown in FIG. 11 at least in respect to constraint parameters 1, 2, 3, 4, and K.

While there have been shown and described and pointed out fundamental novel features of the invention as applied to embodiments thereof, it will be understood that various omissions and substitutions and changes in the form and details of the processes described may be made by those skilled in the art without departing from the spirit of the invention. For example, it is expressly intended that all combinations of those process steps which perform substantially the same function in substantially the same way to achieve the same results are within the scope of the invention. Moreover, it should be recognized that process steps shown and/or described in connection with any disclosed form or embodiment of the invention may be incorporated in any other disclosed or described or suggested form or embodiment as a general matter of design choice. It is the intention, therefore, to be limited only as indicated by the spirit of the independent claims appended hereto. The specific examples provided in the description given above should not be construed as limiting. Therefore, the invention is not limited merely to the embodiments described above, many variants being possible without departing from the spirit of the inventive idea defined in the independent claims.

What is claimed is:

1. A process for pairing off parties on a real estate and housing market, the process comprising:
a service provider enables a first party to submit an earmarking advertisement and a second party to submit an offering advertisement, said earmarking advertisement defining constraint requirements for an object being searched for, said offering advertisement including information about an object being offered, and said second party being enabled to submit said offering advertisement without showing identifying information of said second party to said first party,
the service provider checks whether said object being offered has potential to match said constraint requirements defined in said earmarking advertisement, and
as a response to a situation in which said object being offered in said offering advertisement has potential to match said constraint requirements, the service provider inquires about willingness for further negotiations of at least one of the following: said first party and said second party.

2. A process according to claim 1, wherein said first party is a potential buyer of said object being searched for and said second party is a potential seller of said object being offered.

3. A process according to claim 1, wherein said first party is a potential tenant of said object being searched for and said second party is a potential landlord of said object being offered.

4. A process according to claim 1, wherein said first party generates said earmarking advertisement using a user interface of a first terminal device connected to a data network, said second party generates said offering advertisement using a user interface of a second terminal device connected to said data network, said earmarking advertisement and said offering advertisement are loaded into a database of a server device connected to said data network, and the service provider receives said earmarking advertisement and said offering advertisement by downloading said earmarking advertisement and said offering advertisement from said data base.

5. A process according to claim 1, wherein as a response to a situation in which said second party is willing to negotiate, invitations for tenders to operate as an agent of said second party are sent to one or more realtors, said second party is allowed to select at least one realtor from said one or more realtors on the basis of tenders responding to said invitations for tenders, and contact information of the selected at least one realtor is delivered to said first party.

6. A process according to claim 1, wherein as a response to a situation in which said second party is willing to negotiate, contact information of said second party is delivered to said first party.

7. A process according to claim 1, wherein as a response to a situation in which said second party is willing to negotiate, the service provider submits to said second party a tender to operate as an agent of said second party.

8. A process according to claim 1, wherein as a response to a situation in which said first party is willing to negotiate, invitations for tenders to operate as an agent of said first party are sent to one or more realtors, said first party is allowed to select at least one realtor from said one or more realtors on the basis of tenders responding to said invitations for tenders, and contact information of the selected at least one realtor is delivered to said second party.

9. A process according to claim 1, wherein as a response to a situation in which said first party is willing to negotiate, contact information of said first party is delivered to said second party.

10. A process according to claim 1, wherein as a response to a situation in which said first party is willing to negotiate, the service provider submits to said first party a tender to operate as an agent of said first party.

11. A process according to claim 1, wherein as a response to reception of said earmarking advertisement the service provider contacts said first party and helps said first party to further develop said earmarking advertisement to correspond better with needs of said first party.

12. A process according to claim 1, wherein as a response to reception of said offering advertisement the service provider contacts said second party and helps said second party to further develop said offering advertisement to correspond better with said object being offered.

13. A process according to claim 1, wherein as a response to reception of said earmarking advertisement the service provider informs said first party about presentations concerning said object being offered.

14. A process according to claim 1, wherein the service provider organizes for said first party a first presentation concerning said object being offered and, after said first presentation, the service provider organizes a public presentation concerning said object being offered.
